(19) United States
(12) Patent Application Publication
(10) Pub. No.: US 2010/0005581 A1
(43) Pub. Date: Jan. 14, 2010

(54) WASTE OUTLET

(76) Inventor: James Kenneth McAlpine, Glasgow (GB)

Correspondence Address: DYKAS, SHAVER & NIPPER, LLP, P.O. BOX 877, BOISE, ID, 83701-0877, US

(21) Appl. No.: 12/281,288

(22) PCT Filed: Mar. 2, 2007
(86) PCT No.: PCT/GB2007/000756

§ 371 Date: Dec. 15, 2008

(30) Foreign Application Priority Data
Mar. 2, 2006 (GB) 0604150.3

(51) Int. Cl. E03C 1/26; A47K 1/14; B23P 17/04

(52) U.S. Cl. 4/291; 4/295; 29/592

(57) ABSTRACT

A basket strainer for a sink or bath waste is described. The basket strainer has a bowl-shaped metal body having an edge portion configured to resist deformation, wherein at least a portion of the metal body is less than 1 mm thick.

### FIELD OF INVENTION

The present invention relates to an improved waste outlet for use in a waste, such as a sink or bath waste.

### BACKGROUND OF INVENTION

It is known to use strainer members in combination with plugs in sink wastes, to prevent the entry of solid matter into the sink waste, which may otherwise block the waste outflow pipe. Such strainers are of particular use in kitchen sinks, which are likely to have food particles and the like falling into the waste. Conventional strainers are typically in the form of a disc defining a number of holes which is placed over the waste.

In certain variants of conventional strainers, the disc is bowl-shaped in form, and includes upwardly extending peripheral walls. The shape of the strainer allows it to fit snugly into the opening of the waste outlet, below the sink base, and so improves the straining capability of the strainer.

The conventional bowl-shaped form of strainer, known as a basket strainer, has drawbacks however. If a basket strainer is manufactured by being pressed from metal sheet, a de-burring step to remove burrs from the circumferential upper edge of the basket may be required. Furthermore, the strainer, and particularly the edge, can be damaged or deformed in use by impact of a heavy object, such as a large cooking pan. In some cases, the damage may distort the strainer such that the strainer can no longer snugly fit in the waste outlet as intended. Such damage can be reduced by using heavier gauge material to form the strainer, however, heavier gauge material is more expensive to buy and to process, adding to the unit costs of the finished product.

There are also significant costs associated with the provision of actuation knobs for opening and closing push-pull or push-push type wastes. Conventional actuation knobs can be manufactured from a block of solid material. The knob is generally attached to the other parts of the waste by an internal thread. Particular costs are associated with creation of this internal thread.

### SUMMARY OF INVENTION

According to a first aspect of the present invention there is provided a basket strainer for a sink or bath waste, the basket strainer having a bowl-shaped metal body having an edge portion configured to resist deformation, wherein at least a portion of the metal body is less than 1 mm thick.

Embodiments of the present invention provide a basket strainer which may be used in a bath or sink waste and which is designed to withstand an impact which would otherwise damage or distort the strainer. Providing an edge configured to resist deformation permits a lighter gauge of material to be used than is used in conventional basket strainers. Using material which is less than 1 mm thick provides significant reductions in manufacturing costs.

The bowl may be formed by pressing, drawing or otherwise forming a metal sheet.

Preferably, the bowl-shaped body has a base portion, a peripheral wall and a circumferential edge.

Preferably, the base portion is less then 1 mm thick.

Preferably, the edge portion comprises the circumferential edge and an upper section of the peripheral wall.

Preferably, the edge portion is formed with the circumferential edge below the top of the peripheral wall. As the circumferential edge is below the top of the peripheral wall, the edge is protected in the event of a heavy object, such as a kitchen knife, impacting on the upper portion of the strainer.

Preferably, the basket strainer is formed such that the circumferential edge is “turned back” towards the peripheral wall. Turning back the circumferential edge provides greater impact resistance than an exposed edge of material. The turned back edge also disguises from the user that a lighter gauge material has been used.

Preferably, the portion of the metal body is less then 0.75 mm thick.

Preferably, the portion of the metal body is less then 0.6 mm thick.

Preferably, the portion of the metal body is less then 0.5 mm thick.

Preferably, the portion of the metal body is less then 0.4 mm thick.

Preferably, the portion of the metal body is less then 0.3 mm thick.

Preferably, the circumferential edge is turned back by rolling or folding.

The circumferential edge may be only partially rolled or folded towards the peripheral wall. Partial rolling or folding, that is leaving a gap between the circumferential edge and the adjacent peripheral wall, provides a space which is useful for plating purposes, and ensures that effluent products are not trapped on the inside of the roll during manufacture.

Preferably, the basket strainer is formed such that when in normal use in a sink outlet, the circumferential edge is inaccessible to a user, or at least to a user's fingers. If the circumferential edge is inaccessible to a user's fingers, there is a reduced need to de-burr the circumferential edge during manufacture. De-burring is normally carried out to remove any jagged or sharp edges.

The circumferential edge may be inaccessible to a user by being rolled of folded into contact with the peripheral wall.

Preferably, the basket strainer is formed by folding or rolling the circumferential edge in a radially outward direction.

Preferably, the strainer is configured to conform to the shape of an opening of a waste outlet such that the strainer fits snugly within the waste outlet. As the basket strainer edge portion is configured to resist deformation, the basket strainer may be designed to permit a closer fit to the waste outlet than is normal for a conventional basket strainer.

Preferably, the basket strainer is generally circular and is provided with a plurality of openings.

Preferably, the basket strainer is adapted to be used with the type of waste outlet plug often referred to as a “clicker-waste”. An example of a clicker-waste is described in the Applicant's International Patent publication No. WO2004/100742, the disclosure of which is incorporated herein by reference.

According to a second aspect of the present invention there is provided a waste outlet plug, the plug comprising:

a waste outlet seal;

a basket strainer; and

an actuation member;

wherein the basket strainer has a bowl-shaped metal body having an edge portion configured to resist deformation, at least a portion of the metal body being less than 1 mm thick.

Preferably, the bowl-shaped body has a base portion, a peripheral wall and a circumferential edge.

Preferably, the base portion is less then 1 mm thick.

Preferably, the edge portion comprises the circumferential edge and the top of the peripheral wall, the edge portion being configured to resist deformation by forming the basket strainer with the circumferential edge below the top of the peripheral wall.

Preferably, the basket strainer is formed such that the circumferential edge is “turned back” towards the peripheral wall.

Preferably, the actuation member comprises a metal shroud and an insert. The insert may define an internal coupling profile, for example a bore which may be threaded.

The insert may comprise a settable material, for example, a polymeric material or a low melting point metal or alloy.

Most preferably, the insert is moulded into the shroud, and may be injection moulded.

Preferably, the waste outlet seal, basket strainer, and actuation member are coupled to a stem.

Preferably, a portion of the stem defines an external thread or other profile adapted to engage the actuation member internal thread.

Preferably, in use, the stem is selectively adjustable in length for selectively engaging the seal with a portion of a waste outlet to open and seal the waste outlet. Plugs which are actuable between an outlet open and an outlet sealed position are particularly suited to the inventive basket strainer because the travel of the basket strainer between the open and closed positions is known and therefore the appropriate amount of roll or folding can be selected which is sufficient to make the circumferential edge inaccessible to a user, or at least a user's finger, during normal use.

According to a third aspect of the present invention there is provided an actuation member for a waste outlet plug, the actuation member comprising

a metal shroud; and

a moulded polymeric insert defining an internal coupling profile.

Embodiments of the present invention provide an actuation member which can be made at low cost without the need for machining.

Preferably, the insert is injection moulded.

Preferably, the insert is moulded into the shroud.

Alternatively, the insert is moulded separately.

Preferably, the separately moulded insert is pressed into the shroud.

Alternatively, the shroud is formed around the separately moulded insert.

Preferably, the shroud is an inverted cup shape.

Preferably, the shroud has an upper portion and at least one side wall.

Preferably, the shroud is shaped to resist the insert from being removed therefrom.

Preferably, the at least one side wall defines a recess into which the insert extends, preventing the insert from being removed.

Preferably, the internal coupling profile is an internal thread.

Preferably, the insert defines a threaded bore.

Preferably, the insert is moulded from a settable material.

Preferably, the insert is injection moulded into the shroud.

Alternatively, the at least one side wall tapers inwardly, preventing the insert from being removed.

Preferably, an external surface portion of the shroud is adapted to facilitate gripping.

According to a fourth aspect of the present invention there is provided a method of manufacturing an actuation member for a waste outlet plug, the method comprising the steps of:

pressing a metal shroud; and then

moulding an insert defining an internal coupling profile into the shroud.

According to a fifth aspect of the present invention there is provided a method of manufacturing an actuation member for a waste outlet plug, the method comprising the steps of:

pressing a metal shroud;

moulding an insert defining an internal coupling profile; and then

press fitting the moulding into the shroud.

According to a sixth aspect of the present invention there is provided a method of manufacturing an actuation member for a waste outlet plug, the method comprising the steps of:

moulding an insert defining an internal coupling profile; and then

forming a shroud around the insert.

According to a seventh aspect of the present invention there is provided a method of manufacturing an actuation member for a waste outlet plug, the method comprising the steps of:

partially forming a metal shroud;

moulding an insert defining an internal coupling profile; and then

fully forming the shroud around the insert.

### BRIEF DESCRIPTION OF THE FIGURES

The present invention will now be described by way of example only and with reference to the accompanying Figures, in which:

FIG. 1 is a perspective view of a basket strainer according to a first embodiment of the present invention;

FIG. 2 is a sectional side view of the basket strainer of FIG. 1;

FIG. 3 is a top view of the basket strainer of FIG. 1;

FIG. 4 is an enlarged sectional view of a portion of the basket strainer of FIG. 1;

FIG. 5 is a perspective view of a basket strainer according to a second embodiment of the present invention;

FIG. 6 is a sectional side view of the basket strainer of FIG. 5;

FIG. 7 is a top view of the basket strainer of FIG. 5;

FIG. 8 is an enlarged sectional view of a portion of the basket strainer of FIG. 5;

FIG. 9 is an exploded perspective of an actuation knob for a waste outlet plug or strainer according to a third embodiment of the present invention;

FIG. 10 is a side view of the actuation knob of FIG. 9;

FIG. 11 is a section view of the actuation knob of FIG. 9;

FIG. 12 is an exploded perspective of an actuation knob for a waste outlet plug or strainer according to a fourth embodiment of the present invention;

FIG. 13 is a side view of the actuation knob of FIG. 12;

FIG. 14 is a section view of the actuation knob of FIG. 12;

FIG. 15 is a perspective view of the actuation knob of FIG. 12; and

FIG. 16 is a section view of a waste outlet plug according to a fifth embodiment of the present invention.

### DETAILED DESCRIPTION OF THE FIGURES

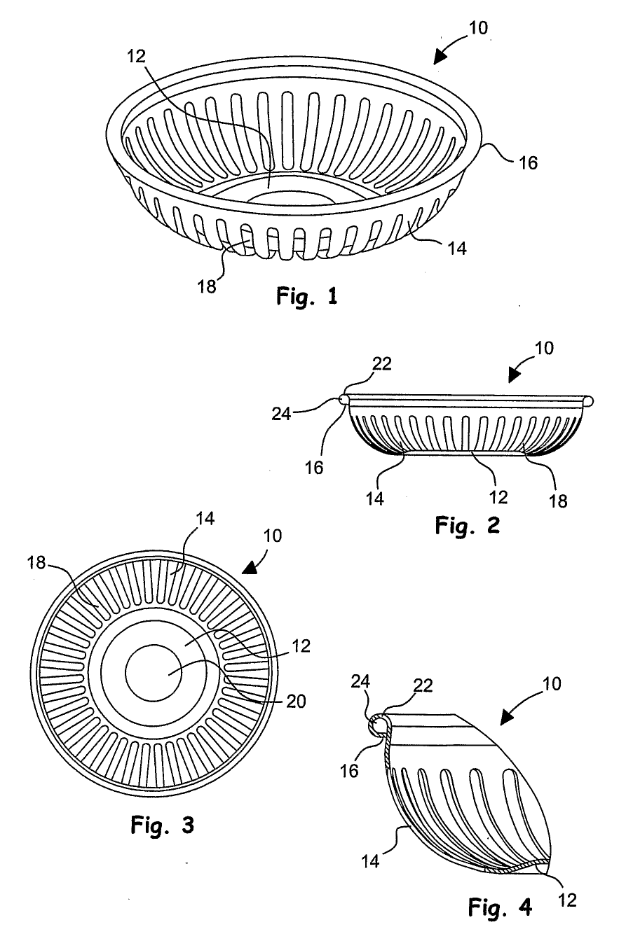

A first embodiment of a basket strainer, generally indicated by reference numeral 10, is shown in FIGS. 1-4.

The basket strainer 10 comprises a base portion 12, a peripheral wall 14 and a circumferential edge 16. The circumferential edge 16 can be seen most clearly in FIG. 4.

The peripheral wall 14 defines a plurality of elongate apertures 18 which are adapted to permit a fluid to pass through whilst retaining at least some of the solid waste products which may be carried by the fluid. The base 12 defines a mounting aperture 20 which is adapted to receive the stem of a waste plug (not shown). The basket strainer 10 is pressed from a disc of sheet stainless steel, grade SS304, 0.75 mm thick.

As can be seen most clearly from FIGS. 2 and 4, the basket strainer 10 has been further formed such that the circumferential edge 16 of the disc is below the top of the peripheral wall 14. This arrangement means, that in use, the circumferential edge 16 is protected from an impact from a heavy object by the peripheral wall 14. As can be seen most clearly in FIGS. 2 and 4, the circumferential edge 16 has been rolled to this configuration. This arrangement is advantageous in that the circumferential edge 16 is adjacent with the peripheral wall 14 with the result that a user cannot make contact with the circumferential edge 16 easily meaning the edge 16 does not need to be de-burred.

The roll of material 24 defined by rolling the circumferential edge 16 to the position shown in FIGS. 2 and 4 provides rigidity to the basket strainer 10, permitting a lower grade or gauge of material to be used than would be normal, and a user gripping the basket strainer 10 by the roll 24, or simply viewing the strainer 10, would be under the impression that a heavier grade of material has been used than has actually been used.

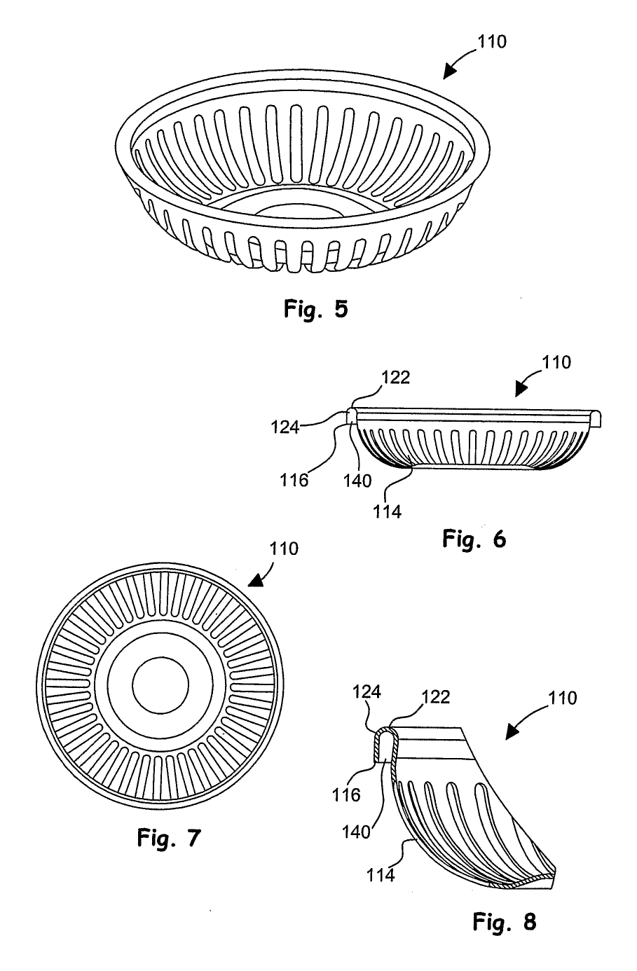

Referring now to FIGS. 5-8, there are shown views of a basket strainer 110 according to a second embodiment of the present invention. Many of the features of the second embodiment are the same as the first embodiment, and where appropriate the reference numeral of the first embodiment has been used in the second embodiment with the addition of 100.

Referring to FIGS. 5-8, in this case, the circumferential edge 116 has been rolled to form an inverted channel. The circumferential edge 116 extends downwards from the top 122 of the peripheral wall 114 and provides the comparable impact resistance, rigidity and quality feel of the first embodiment. However, in this case there is a larger gap 140 between the circumferential edge 116 and the wall 114. The gap 140 ensures that effluent which may be present during the manufacturing process is not trapped and additionally facilitates the entire basket strainer 110 to be plated post-forming, that is the plating material can enter the inside of the roll 124. In this embodiment, however, the circumferential edge 116 is not concealed by contact with the peripheral wall 114 and some de-burring of the edge 116 may be necessary or desirable. However, the amount of de-burring that is necessary would be less than is the case for a conventional basket strainer.

Where the basket strainer 110 is used with a clicker-waste, of the type'described in the Applicant's International Patent publication No. WO2004/100742, the circumferential edge 116 may extend downwards sufficiently, such that when the basket strainer 110 is in the raised position, the edge 116 is inaccessible to a user. As the user cannot touch the circumferential edge 116 de-burring of the edge 116 is not critical.

In both described embodiments, the improved rigidity created by the roll 24, 124 has the additional advantage that the gap between the basket strainer 10,110 and a waste outlet, when the basket strainer 10, 110 is in use in a sink, can be reduced, if desired. The improved rigidity will resist deformity of the basket strainer 10,110 through use with the result that the installer can be confident that a snug fit between the basket strainer 10, 110 and the waste outlet can be maintained.

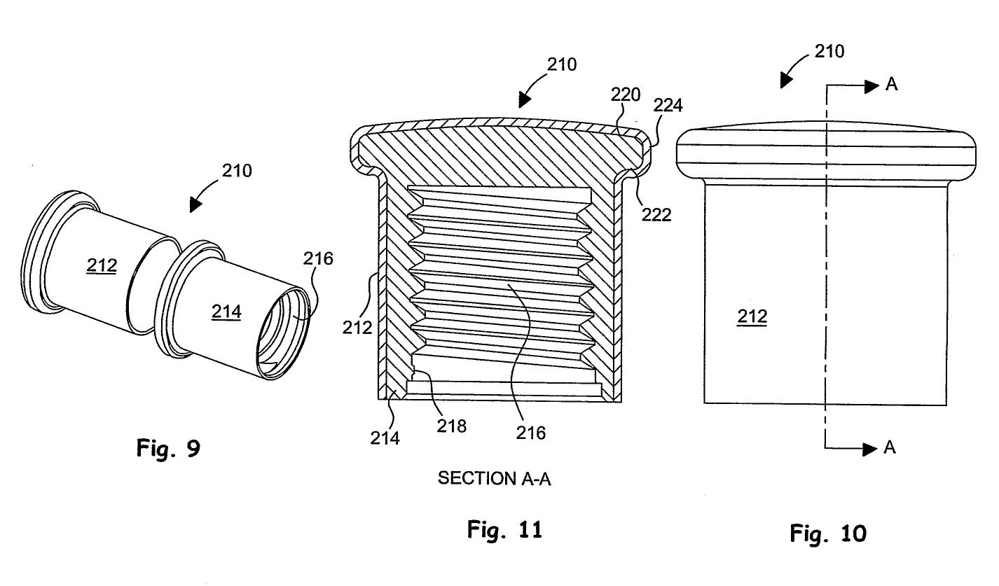

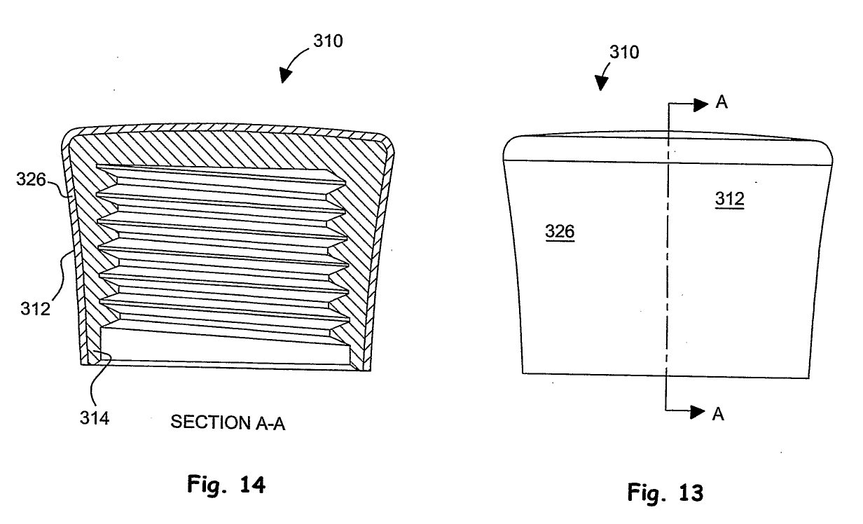

Referring now to FIG. 9, there is shown an exploded perspective of an actuation knob 210 for a waste outlet plug or strainer according to a third embodiment of the present invention. Further views of the knob 210 can be seen in FIGS. 10 and 11, side and section views of the knob 210 respectively.

The knob 210 comprises a cup-shaped shroud 212 and a acetal insert 214. The shroud 212 is pressed from stainless steel and the insert 214 is injection moulded into the shroud 212.

The insert 214 is moulded to define a blind bore 216 defining an internal thread 218. As the threaded bore 216 is created during the moulding process no further processing is required to complete the knob 210.

It is undesirable for the insert 214 to be removable from the shroud 212. To ensure the insert 214 can not be removed, the shroud 212 is provided with a recess 220. As the polymer is injected into the shroud 210 to form the insert, an insert lug 222 forms within the recess 220. The lug 222 prevents the insert 214 from being removed.

The external side 224 of the recess 220 also serves as grip for a user to hold when actuating the knob 210.

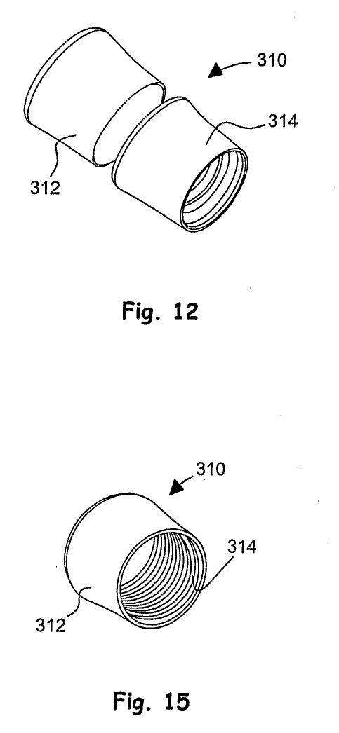

FIG. 12 shows an exploded perspective view of an alternative knob 310 according to a fourth embodiment of the present invention. FIGS. 13, 14 and 15 show side, section and perspective views of the knob 310.

This knob 310 utilises a different method of retaining the insert 314 within the shroud 312. In this case the shroud side walls 326 taper inwardly, trapping the insert 314 within the shroud 312.

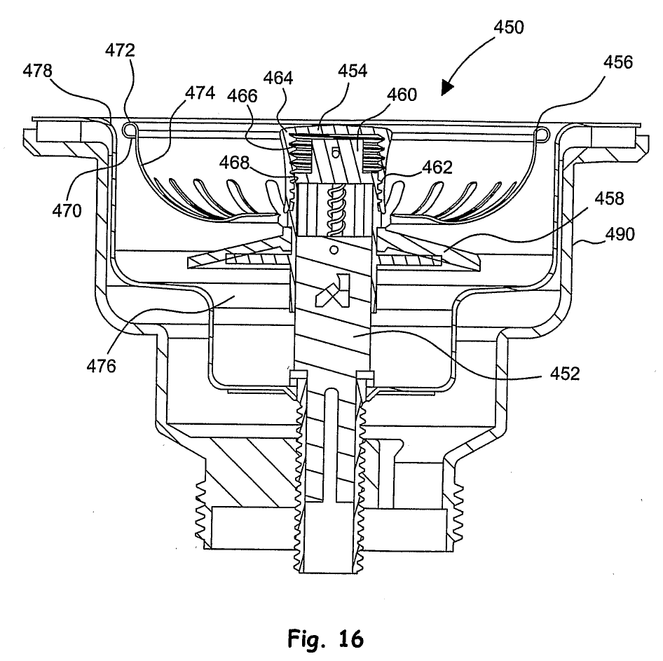

Finally, FIG. 16 shows a section view of a waste outlet plug 450 according to a fifth aspect of the present invention.

The plug comprises a stem 452, an actuation knob 454, a basket strainer 456 and an outlet seal 458. The plug is shown located in a waste outlet unit 490.

The stem 452 is selectively adjustable in length. The stem 452 includes a cap 460, defining an external thread 462. The actuation knob 454 comprises a shroud 464 and an insert 466, defining an internal thread 468. The knob 454 is attached to the stem 452 by engagement of the insert thread 468 and the stem thread 462.

The basket strainer 456 has a circumferential edge 470 which is below the top 472 of the strainer wall 474.

The stem 452 is selectively adjustable in length between a waste outlet sealed position, in which the outlet seal 458 engages and seals an outlet 476, and a waste outlet open position, in which the outlet seal 458 is displaced axially from the waste outlet 476. The position shown in FIG. 16 is the outlet open position. The length of the stem 452 is adjusted by pressing on the actuation knob 454.

As can be seen from FIG. 16, the circumferential edge 470 is formed such that in the waste outlet open position, the edge 470 is located below the upper edge 478 of the waste outlet unit 490. This ensures that in normal use the edge 470 is not accessible by a user's fingers.

It will be understood that the foregoing is for illustrative purposes only, and that the skilled person will be able to conceive of variations which may be made to the described embodiments, without departing from the invention. For example, the actuation knob is shown as circular. Any suitable shape, such as elliptical could be chosen.

1. A basket strainer for a sink or bath waste, the basket strainer having a bowl-shaped metal body having an edge portion configured to resist deformation, wherein at least a portion of the metal body is less than 1 mm thick.

2. The basket strainer of claim 1, wherein the bowl may be formed by pressing, drawing or otherwise forming a metal sheet.

3. The basket strainer of claim 1, wherein the bowl-shaped body has a base portion, a peripheral wall and a circumferential edge.

4. The basket strainer of claim 3, wherein the base portion is less then 1 mm thick.

5. The basket strainer of claim 3, wherein the edge portion comprises the circumferential edge and an upper section of the peripheral wall.

6. The basket strainer of claim 3, wherein the edge portion is formed with the circumferential edge below the top of the peripheral wall.

7. The basket strainer of claim 3, wherein the basket strainer is formed such that the circumferential edge is “turned back” towards the peripheral wall.

8. The basket strainer of claim 1, wherein the portion of the metal body is less than 0.75 mm thick.

9. The basket strainer of claim 1, wherein the portion of the metal body is less than 0.6 mm thick.

10. The basket strainer of claim 1, wherein the portion of the metal body is less than 0.5 mm thick.

11. The basket strainer of claim 1, wherein the portion of the metal body is less than 0.4 mm thick.

12. The basket strainer of claim 1, wherein the portion of the metal body is less than 0.3 mm thick.

13. The basket strainer of claim 7, wherein the circumferential edge is turned back by rolling or folding.

14. The basket strainer of claim 13, wherein the circumferential edge is only partially rolled or folded towards the peripheral wall.

15. The basket strainer of claim 13, wherein the basket strainer is formed such that when in normal use in a sink outlet, the circumferential edge is inaccessible to a user, or at least to a user's fingers.

16. The basket strainer of claim 7, wherein the circumferential edge is rolled or folded into contact with the peripheral wall.

17. The basket strainer of claim 7, wherein the basket strainer is formed by folding or rolling the circumferential edge in a radially outward direction.

18. The basket strainer of claim 1, wherein the strainer is configured to conform to the shape of an opening of a waste outlet such that the strainer fits snugly within the waste outlet.

19. The basket strainer of claim 1, wherein the basket strainer is adapted to be used with the type of waste outlet plug often referred to as a “clicker-waste”.

20. A waste outlet plug, the plug comprising:
a waste outlet seal;
a basket strainer; and
an actuation member;
wherein the basket strainer has a bowl-shaped metal body having an edge portion configured to resist deformation, at least a portion of the metal body being less than 1 mm thick.

21. The waste outlet plug of claim 20, wherein the bowl-shaped body has a base portion, a peripheral wall and a circumferential edge.

22. The waste outlet plug of claim 21, wherein the base portion is less than 1 mm thick.

23. The waste outlet plug of claim 21, wherein the edge portion comprises the circumferential edge and the top of the peripheral wall, the edge portion being configured to resist deformation by forming the basket strainer with the circumferential edge below the top of the peripheral wall.

24. The waste outlet plug of claim 21, wherein the basket strainer is formed such that the circumferential edge is “turned back” towards the peripheral wall.

25. The waste outlet plug of claim 21, wherein theactuation member comprises a metal shroud and an insert.

26. The waste outlet plug of claim 25, wherein the insert comprises a settable material, for example, a polymeric material or a low melting point metal or alloy.

27. The waste outlet plug of claim 25, wherein the insert is moulded into the shroud, and may be injection moulded.

28. The waste outlet plug of claim 20, wherein the waste outlet seal, basket strainer, and actuation member are coupled to a stem.

29. The waste outlet plug of claim 28, wherein a portion of the stem defines an external thread or other profile adapted to engage the actuation member internal thread.

30. The waste outlet plug of claim 28, wherein, in use, the stem is selectively adjustable in length for selectively engaging the seal with a portion of a waste outlet to open and seal the waste outlet.

31. An actuation member for a waste outlet plug, the actuation member comprising
a metal shroud; and
a moulded polymeric insert defining an internal coupling profile.

32. The actuation member of claim 31, wherein the insert is injection moulded.

33. The actuation member of claim 32, wherein the insert is moulded into the shroud.

34. The actuation member of claim 32, wherein the insert is moulded separately.

35. The actuation member of claim 34, wherein the separately moulded insert is pressed into the shroud.

36. The actuation member of claim 34, wherein the shroud is formed around the separately moulded insert.

37. The actuation member of claim 31, wherein the shroud is an inverted cup shape.

38. The actuation member of claim 31, wherein the shroud has an upper portion and at least one side wall.

39. The actuation member of claim 31, wherein the shroud is shaped to resist the insert from being removed therefrom.

40. The actuation member of claim 39, wherein the at least one side wall defines a recess into which the insert extends, preventing the insert from being removed.

41. The actuation member of claim 31, wherein the internal coupling profile is an internal thread.

42. The actuation member of claim 31, wherein the insert defines a threaded bore.

43. The actuation member of claim 39, wherein the at least one side wall tapers inwardly, preventing the insert from being removed.

44. A method of manufacturing an actuation member for a waste outlet plug, the method comprising the steps of:
pressing a metal shroud; and then
moulding an insert defining an internal coupling profile into the shroud.

45. A method of manufacturing an actuation member for a waste outlet plug, the method comprising the steps of:
pressing a metal shroud;
moulding an insert defining an internal coupling profile; and then
press fitting the moulding into the shroud.

46. A method of manufacturing an actuation member for a waste outlet plug, the method comprising the steps of:
moulding an insert defining an internal coupling profile; and then
forming a shroud around the insert.

47. A method of manufacturing an actuation member for a waste outlet plug, the method comprising the steps of:
partially forming a metal shroud;
moulding an insert defining an internal coupling profile; and then
fully forming the shroud around the insert.
